(19) United States
(12) Patent Application Publication
(10) Pub. No.: US 2014/0185250 A1
(43) Pub. Date: Jul. 3, 2014

(54) MOTHERBOARD WITH COMPATIBLE INTERFACE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: GUI-FU XIAO, Shenzhen (CN); WEI PANG, Shenzhen (CN); CHENG-FEI WENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/011,757

(22) Filed: Aug. 28, 2013

(30) Foreign Application Priority Data
Dec. 28, 2012 (CN) 2012105821000

(51) Int. Cl. H01R 27/00

(52) U.S. Cl. CPC H01R 27/00
USPC 361/748

(57) ABSTRACT

A motherboard includes an interface and a switch module. The interface includes first to eighth pins used to connect a component object model (COM) connector or a registered jack 45 (RJ45) connector. The switch module is connected to the interface. The switch module is also connected to a serial communication bus and an Ethernet bus on the motherboard. The switch module is used to determine the type of a connector connected to the interface, and connect the connector to the serial communication bus or the Ethernet bus according to the determination.

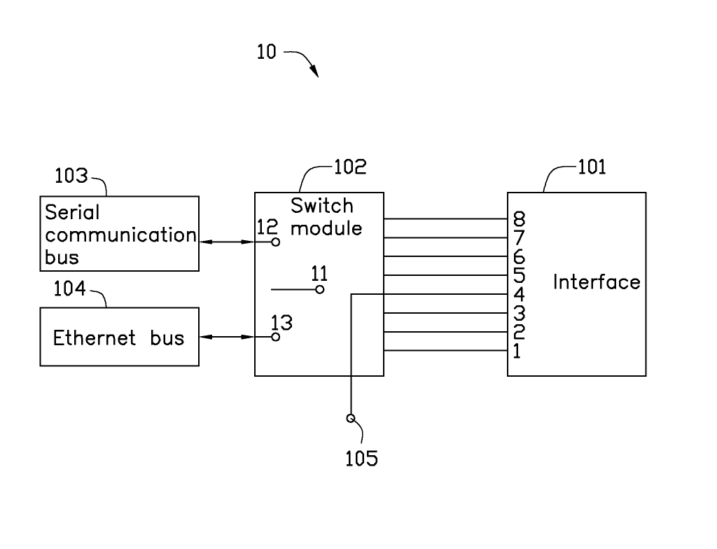

### BACKGROUND

1. Technical Field

The present disclosure relates to a motherboard with a compatible interface.

2. Description of Related Art

Registered jack (RJ) connectors generally include two types, one of which is for connecting telecommunications, and the other of which is for computer Internet. Shapes of the RJ connectors are similar. Thus, if the RJ connectors used for connecting telecommunications are wrongly used for computer Internet, network communication cannot be achieved, which is inconvenient.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a block diagram of an embodiment of a motherboard with a compatible interface of the present disclosure.

### DETAILED DESCRIPTION

The FIGURE shows an embodiment of a motherboard 10 of the present disclosure.

The motherboard 10 includes an interface 101 and a switch module 102.

Structure of the interface 101 is the same as a component object model (COM) interface for connecting telecommunications and a registered jack 45 (RJ45 interface for ethernet, which includes first to eighth pins 1-8.

The fourth pin of a COM connector is a ground pin and the fourth pin of a RJ45 connector is a data pin. Functions of other pins of the two connectors are the same.

The switch module 102 is connected to the first to eighth pins 1-8 of the interface 101. The switch module 102 is connected to a serial communication bus 103 and an Ethernet bus 104 on the motherboard 10. The switch module 102 is used to determine the type of the connector connected to the interface 101, and then connect the serial communication bus 103 or the Ethernet bus 104 to the interface 101 according to the determination made by the switch module 102.

In this embodiment, the switch module 102 includes first to third groups of pins 11-13 and a control pin 105. The first group of pins 11 is connected to the interface 101. The second group of pins 12 is connected to the serial communication bus 103. The third group of pins 13 is connected to the Ethernet bus 104. The control pin 105 is connected to the fourth pin of the interface 101.

When a COM connector is connected to the interface 101, the fourth pin of the interface 101 is grounded and the control pin 105 of the switch module 102 receives a low level signal. The switch module 102 connects the first group of pins 11 to the second group of pins 12. The COM connector for connecting telecommunications is electrically connected to the serial communication bus 103.

When an RJ45 connector is connected to the interface 101, the fourth pin of the interface 101 receives a high level signal transferred from the RJ45 connector. The control pin 105 of the switch module 102 receives the high level signal. The switch module 102 connects the first group of pins 11 to the third group of pins 13. The RJ45 connector is electrically connected to the Ethernet bus 104.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A motherboard, comprising:
an interface comprising first to eighth pins to connect a component object model (COM) connector and a registered jack 45 (RJ45) connector;
a switch module connected to the interface, a serial communication bus, and an Ethernet bus; the switch module determining a type of the connector connected to the interface, and connect the connector to the serial communication bus or the Ethernet bus according to the determination.

2. The motherboard of claim 1, wherein the switch module comprises first to third groups of pins and a control pin, the first group of pins is connected to the interface, the second group of pins is connected to the serial communication bus, the third group of pins is connected to the Ethernet bus, the control pin is connected to a fourth pin of the interface, when a COM connector is connected to the interface, the fourth pin of the interface is grounded and the control pin of the switch module receives a low level signal, the switch module connects the first group of pins to the second group of pins, the COM connector is electrically connected to the serial communication bus, wherein when an RJ45 connector is connected to the interface, the fourth pin of the interface receives a high level signal transferred from the RJ45 connector, the control pin of the switch module receives the high level signal, the switch module connects the first group of pins to the third group of pins, the RJ45 connector is electrically connected to the serial communication bus.
